(19) United States
(12) Patent Application Publication
(10) Pub. No.: US 2010/0037308 A1
(43) Pub. Date: Feb. 11, 2010

(54) MULTI-SERVICE PROVIDER AUTHENTICATION

(75) Inventors: George Chia-Fan Lin, Del Mar, CA (US); Steven R. Hart, Carlsbad, CA (US); Corey Ryan Johnson, San Diego, CA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/406,847

(22) Filed: Mar. 18, 2009

Related U.S. Application Data
(63) Continuation of application No. PCT/US2007/079561, filed on Sep. 26, 2007.
(60) Provisional application No. 60/828,021, filed on Oct. 3, 2006.

(51) Int. Cl. H04L 9/32; H04B 7/00

(52) U.S. Cl. 726/12; 455/517

(57) ABSTRACT

Network access providers implement interactive procedures and subscriber terminals employ embedded secure authentication structures and procedures to ensure that a satellite modem at the subscriber terminal accurately verifies the identity of a satellite modem terminal system at the location of the network access provider gateway facility during the satellite modem initialization process so that the satellite modem will only attempt to acquire satellite resource from the appropriate (authenticated and authorized) satellite modem termination system. In a virtual downstream channel environment, diverse downstream channel feeds are distinguished by authentication procedures. The present invention differs from standard theft of service prevention because theft of subscriber prevention is in a virtual channel environment, where subscriber terminals have access to a plurality of virtual channels by the nature of the signal.

### CROSS-REFERENCE TO RELATED APPLICATIONS

The present application is a continuation of PCT Application Serial No. PCT/US2007/079561, filed on Sep. 26, 2007, entitled “Multi-Service Provider Authentication,” and claims benefit under 35 USC119(e) of U.S. provisional Application No. 60/828,021, filed on Oct. 3, 2006, entitled “Multi-Service Provider Subscriber Authentication,” and expressly incorporates by reference each of the following patent applications in their entirety for all purposes:
PCT Application Serial No. PCT/US07/79577, filed Sep. 26, 2007, entitled “Improved Spot Beam Satellite Ground Systems” (Attorney Docket No. 017018-009510PC);
PCT Application Serial No. PCT/US2007/079565, filed Sep. 26, 2007, entitled “Large Packet Concatenation In Satellite Communication System” (Attorney Docket No. 017018-008210PC);
PCT Application Serial No. PCT/US2007/079569, filed Sep. 26, 2007, entitled “Upfront Delayed Concatenation In Satellite Communication System” (Attorney Docket No. 017018-010510PC);
PCT Application Serial No. PCT/US2007/79571, filed Sep. 26, 2007, entitled “Map-Trigger Dump Of Packets In Satellite Communication System” (Attorney Docket No. 017018-010610PC);
PCT Application Serial No. PCT/US2007/079563, filed Sep. 26, 2007, entitled “Web/Bulk Transfer Preallocation Of Upstream Resources In A Satellite Communication System” (Attorney Docket No. 017018-010710PC);
PCT Application Serial No. PCT/US2007/079567, filed Sep. 26, 2007, entitled “Improved Spot Beam Satellite Systems” (Attorney Docket No. 017018-008010PC);
PCT Application Serial No. PCT/US07/79517, filed Sep. 26, 2007, entitled “Downstream Waveform Sub-Channelization For Satellite Communications” (Attorney Docket No. 026258-002400PC);
PCT Application Serial No. PCT/US07/79523, filed Sep. 26, 2007, entitled “Packet Reformatting For Downstream Links” (Attorney Docket No. 026258-002700PC); and
PCT Application Serial No. PCT/US07/79541, filed Sep. 26, 2007, entitled “Upstream Resource Allocation For Satellite Communications” (Attorney Docket No. 026258-002800PC);
U.S. Provisional Patent Application No. 60/828,044, filed Oct. 3, 2006 for “Web/Bulk Transfer Preallocation Of Upstream Resources In A Satellite Communication System” (Attorney Docket No. 017018-010700US);
U.S. Continuation-in-Part patent application Ser. No. 11/538,431, filed Oct. 3, 2006 for “Code Reuse Multiple Access For A Satellite Return Link” (Attorney Docket No. 017018-001212US);
U.S. Continuation-in-Part patent application Ser. No. 11/538,429, filed Oct. 3, 2006 for “Method For Congestion Management” (Attorney Docket No. 017018-006110US);

### FIELD OF THE INVENTION

The present invention relates to wireless communications in general and, in particular, to a satellite communications network.

### BACKGROUND OF THE INVENTION

Consumer broadband satellite services are gaining traction in North America with the start up of star network services using Ka band satellites. While such first generation satellite systems may provide multi-gigabit per second (Gbps) per satellite overall capacity, the design of such systems inherently limits the number of customers that may be adequately served. Moreover, the fact that the capacity is split across numerous coverage areas further limits the bandwidth to each subscriber.

While existing designs have a number of capacity limitations, the demand for such broadband services continues to grow. The past few years have seen strong advances in communications and processing technology. This technology, in conjunction with selected innovative system and component design, may be harnessed to produce a novel satellite communications system to address this demand.

### Multi-Service Provider Subscriber Authentication

Unlike the world of information distribution via terrestrial cable systems, where there are safeguards against the theft of service, by unauthorized users from the single authorized legitimate cable service provider, which operates under the DOCSIS technology (Data-Over-Cable Service Interface Specification), in the satellite information delivery world, there is a risk of “theft of subscriber” through unauthorized use of a terminal that is intended for use to access one service provider to access the services of another service provider. What is needed is a mechanism to minimize such a risk.

### SUMMARY OF THE INVENTION

According to the invention, in a data over satellite system, network access providers implement interactive procedures and subscriber terminals employ embedded secure authentication structures and procedures to ensure that a satellite modem (SM) at the subscriber terminal accurately verifies the identity of a satellite modem terminal system at the location of the network access provider gateway facility during the satellite modem initialization process so that the satellite modem will only attempt to acquire satellite resource from the appropriate satellite modem termination system, namely a termination system that is both authenticated and authorized. In a virtual downstream channel environment, diverse downstream channel feeds are distinguished by authentication procedures. The present invention differs from standard theft of service prevention because theft of subscriber prevention is in a virtual channel environment, where subscriber terminals have access to a plurality of virtual channels by the nature of the signal.

The invention will be better understood by reference to the following detailed description in connection with the accompanying drawings.

### BRIEF DESCRIPTION OF THE DRAWINGS

FIGS. 1A and 1B are block diagrams of a satellite communication system

FIGS. 2A and 2B are maps showing geographical distributions of beams.

FIG. 3 is a block diagram of a gateway system.

FIG. 4 is a block diagram of a control system.

FIG. 5 is a block diagram of communication and control elements of a satellite relay.

FIGS. 6A and 6B are block diagrams of upstream and downstream translators of FIG. 5.

FIG. 7 is a block diagram of a subscriber facility with a subscriber terminal.

FIG. 8 is a timing diagram of a forward channel superframe.

FIG. 9 is a timing diagram of a typical return channel superframe.

FIG. 10 is a block diagram of a gateway transmitter.

FIG. 11 is a block diagram of a gateway receiver.

FIGS. 12A and 12B are diagrams illustrating frequency allocation of a gateway.

FIG. 13 is a block diagram of a forward channel and return channels in a relay satellite.

FIG. 14 is a diagram illustrating steps of the user initialization and process and of the system architecture without the authentication process.

FIG. 15 is a diagram of the architecture for management of authentication according to the invention.

FIG. 16 is a diagram of the gateway SMTS validation chain at the user SM.

FIG. 17 is a diagram illustrating implementation of the user terminal satellite modem (SM) initialization process with an added the Network Access Provider Authentication (NAPA) procedure.

FIG. 18 is a flow chart of the process at the SM for performing the authentication operations in the broadcast phase.

FIG. 19 is a flow chart of the process at the SM for performing the authentication operations in the interactive phase.

### DETAILED DESCRIPTION OF THE INVENTION

Various embodiments of the present invention comprise systems, methods, devices, and software for a novel broadband satellite network. This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, a number of steps may be required before, after, or concurrently with the following embodiments.

It should also be appreciated that the following systems, methods, devices, and software may be a component of a larger system, wherein other procedures may take precedence over or otherwise modify their application.

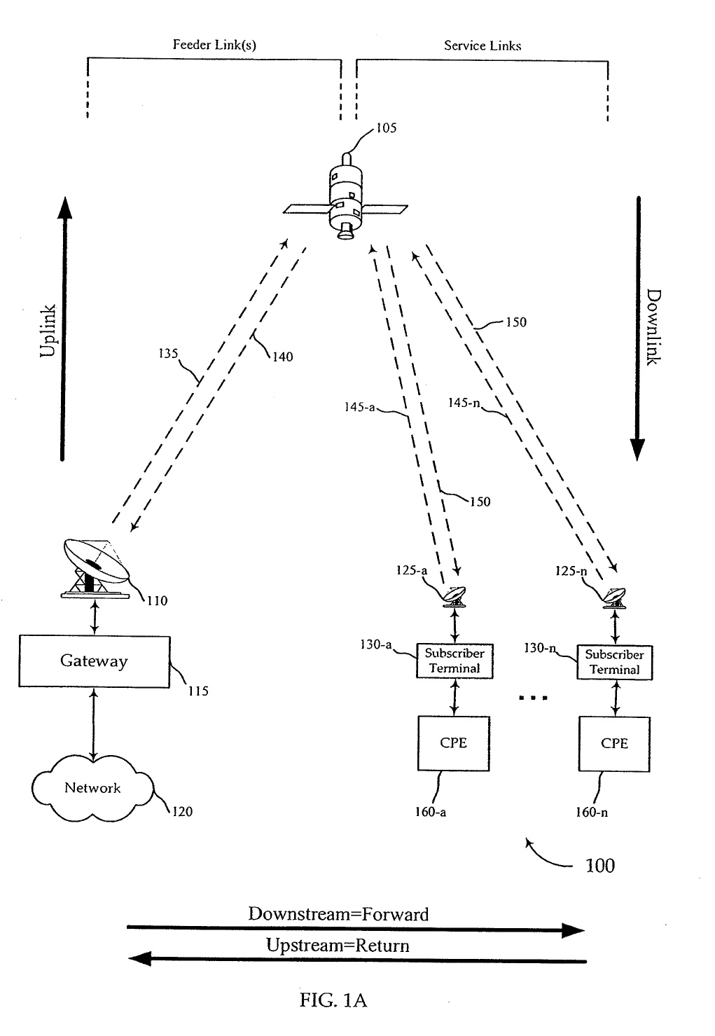

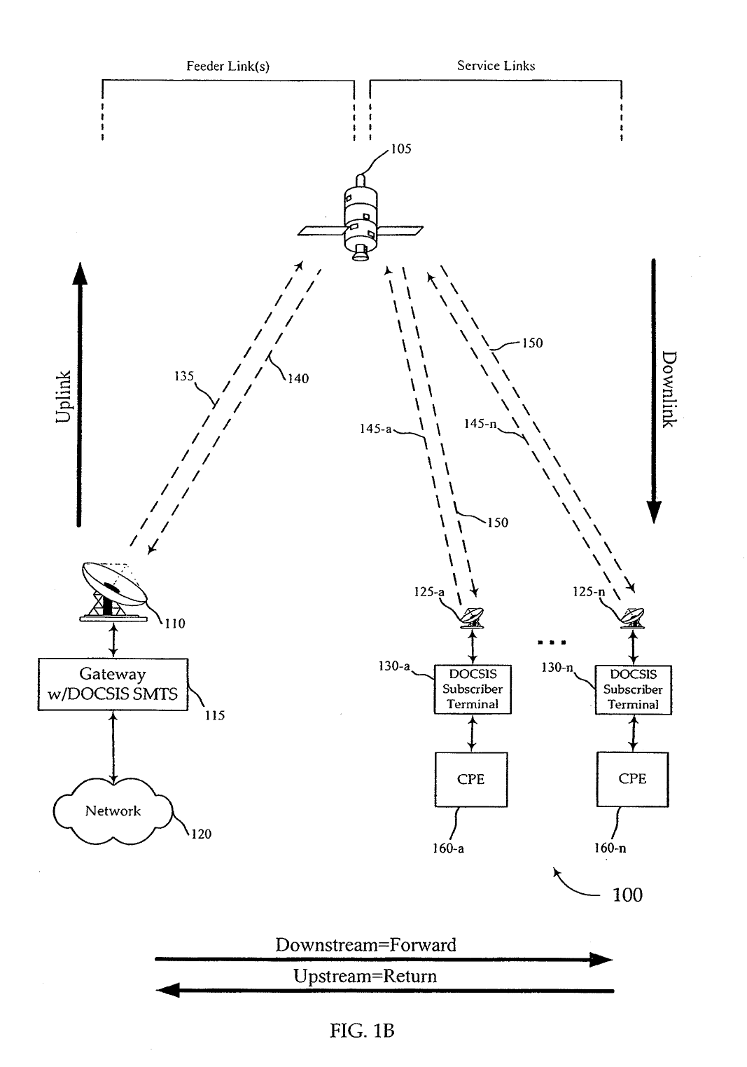

FIG. 1A is a block diagram of an exemplary satellite communications system 100 configured according to various embodiments of the invention. The satellite communications system 100 includes a network 120, such as the Internet, interfaced with a gateway 115 that is configured to communicate with one or more subscriber terminals 130, via a satellite 105. A gateway 115 is sometimes referred to as a hub or ground station. Subscriber terminals 130 are sometimes called modems, satellite modems or user terminals. As noted above, although the communications system 100 is illustrated as a geostationary satellite 105 based communication system, it should be noted that various embodiments described herein are not limited to use in geostationary satellite based systems, for example some embodiments could be low earth orbit (LEO) satellite based systems.

The network 120 may be any type of network and can include, for example, the Internet, an IP network, an intranet, a wide-area network (“WAN”), a local-area network (“LAN”), a virtual private network, the Public Switched Telephone Network (“PSTN”), and/or any other type of network supporting data communication between devices described herein, in different embodiments. A network 120 may include both wired and wireless connections, including optical links. Many other examples are possible and apparent to those skilled in the art in light of this disclosure. As illustrated in a number of embodiments, the network may connect the gateway 115 with other gateways (not pictured), which are also in communication with the satellite 105.

The gateway 115 provides an interface between the network 120 and the satellite 105. The gateway 115 may be configured to receive data and information directed to one or more subscriber terminals 130, and can format the data and information for delivery to the respective destination device via the satellite 105. Similarly, the gateway 115 may be configured to receive signals from the satellite 105 (e.g., from one or more subscriber terminals) directed to a destination in the network 120, and can format the received signals for transmission along the network 120.

A device (not shown) connected to the network 120 may communicate with one or more subscriber terminals, and through the gateway 115. Data and information, for example IP datagrams, may be sent from a device in the network 120 to the gateway 1 15. The gateway 115 may format a Medium Access Control (MAC) frame in accordance with a physical layer definition for transmission to the satellite 130. A variety of physical layer transmission modulation and coding techniques may be used with certain embodiments of the invention, including those defined with the DVB-S2 and WiMAX standards. The link 135 from the gateway 115 to the satellite 105 may be referred to hereinafter as the downstream uplink 135.

The gateway 115 may use an antenna 110 to transmit the signal to the satellite 105. In one embodiment, the antenna 110 comprises a parabolic reflector with high directivity in the direction of the satellite and low directivity in other directions. The antenna 110 may comprise a variety of alternative configurations and include operating features such as high isolation between orthogonal polarizations, high efficiency in the operational frequency bands, and low noise.

In one embodiment, a geostationary satellite 105 is configured to receive the signals from the location of antenna 110 and within the frequency band and specific polarization transmitted. The satellite 105 may, for example, use a reflector antenna, lens antenna, array antenna, active antenna, or other mechanism known in the art for reception of such signals. The satellite 105 may process the signals received from the gateway 115 and forward the signal from the gateway 115 containing the MAC frame to one or more subscriber terminals 130. In one embodiment, the satellite 105 operates in a multi-beam mode, transmitting a number of narrow beams each directed at a different region of the earth, allowing for frequency re-use. With such a multibeam satellite 105, there may be any number of different signal switching configurations on the satellite, allowing signals from a single gateway 115 to be switched between different spot beams. In one embodiment, the satellite 105 may be configured as a “bent pipe” satellite, wherein the satellite may frequency convert the received carrier signals before retransmitting these signals to their destination, but otherwise perform little or no other processing on the contents of the signals. A variety of physical layer transmission modulation and coding techniques may be used by the satellite 105 in accordance with certain embodiments of the invention, including those defined with the DVB-S2 and WiMAX standards. For other embodiments a number of configurations are possible (e.g., using LEO satellites, or using a mesh network instead of a star network), as evident to those skilled in the art.

The service signals transmitted from the satellite 105 may be received by one or more subscriber terminals 130, via the respective subscriber antenna 125. In one embodiment, the antenna 125 and terminal 130 together comprise a very small aperture terminal (VSAT), with the antenna 125 measuring approximately 0.6 meters in diameter and having approximately 2 watts of power. In other embodiments, a variety of other types of antennas 125 may be used at the subscriber terminal 130 to receive the signal from the satellite 105. The link 150 from the satellite 105 to the subscriber terminals 130 may be referred to hereinafter as the downstream downlink 150. Each of the subscriber terminals 130 may comprise a single user terminal or, alternatively, comprise a hub or router (not pictured) that is coupled to multiple user terminals. Each subscriber terminal 130 may be connected to consumer premises equipment (CPE) 160 comprising, for example computers, local area networks, Internet appliances, wireless networks, etc.

In one embodiment, a Multi-Frequency Time-Division Multiple Access (MF-TDMA) scheme is used for upstream links 140, 145, allowing efficient streaming of traffic while maintaining flexibility in allocating capacity among each of the subscriber terminals 130. In this embodiment, a number of frequency channels are allocated which may be fixed, or which may be allocated in a more dynamic fashion. A Time Division Multiple Access (TDMA) scheme is also employed in each frequency channel. In this scheme, each frequency channel may be divided into several timeslots that can be assigned to a connection (i.e., a subscriber terminal 130). In other embodiments, one or more of the upstream links 140, 145 may be configured with other schemes, such as Frequency Division Multiple Access (FDMA), Orthogonal Frequency Division Multiple Access (OFDMA), Code Division Multiple Access (CDMA), or any number of hybrid or other schemes known in the art.

A subscriber terminal, for example 130-a, may transmit data and information to a network 120 destination via the satellite 105. The subscriber terminal 130 transmits the signals via the upstream uplink 145-a to the satellite 105 using the antenna 125-a. A subscriber terminal 130 may transmit the signals according to a variety of physical layer transmission modulation and coding techniques, including those defined with the DVB-S2 and WiMAX standards. In various embodiments, the physical layer techniques may be the same for each of the links 135, 140, 145, 150, or may be different. The link from the satellite 105 to the gateway 115 may be referred to hereinafter as the upstream downlink 140.

Turning to FIG. 1B, a block diagram is shown illustrating an alternative embodiment of a satellite communication system 100. This communication system 100 may, for example, comprise the system 100 of FIG. 1A, but is in this instance described with greater particularity. In this embodiment, the gateway 115 includes a Satellite Modem Termination System (SMTS), which is based at least in part on the Data-Over-Cable Service Interface Standard (DOCSIS). The SMTS in this embodiment includes a bank of modulators and demodulators for transmitting signals to and receiving signals from subscriber terminals 130. The SMTS in the gateway 115 performs the real-time scheduling of the signal traffic through the satellite 105, and provides the interfaces for the connection to the network 120.

In this embodiment, the subscriber terminals 135 use portions of DOCSIS-based modem circuitry, as well. Therefore, DOCSIS-based resource management, protocols, and schedulers may be used by the SMTS for efficient provisioning of messages. DOCSIS-based components may be modified, in various embodiments, to be adapted for use therein. Thus, certain embodiments may utilize certain parts of the DOCSIS specifications, while customizing others.

While a satellite communications system 100 applicable to various embodiments of the invention is broadly set forth above, a particular embodiment of such a system 100 will now be described. In this particular example, approximately 2 gigahertz (GHz) of bandwidth is to be used, comprising four 500 megahertz (MHz) bands of contiguous spectrum. Employment of dual-circular polarization results in usable frequency comprising eight 500 MHz non-overlapping bands with 4 GHz of total usable bandwidth. This particular embodiment employs a multi-beam satellite 105 with physical separation between the gateways 115 and subscriber spot beams, and configured to permit reuse of the frequency on the various links 135, 140, 145, 150. A single Traveling Wave Tube Amplifier (TWTA) is used for each service link spot beam on the downstream downlink, and each TWTA is operated at full saturation for maximum efficiency. A single wideband carrier signal, for example using one of the 500 MHz bands of frequency in its entirety, fills the entire bandwidth of the TWTA, thus allowing a minimum number of space hardware elements. Spotbeam size and TWTA power may be optimized to achieve maximum flux density on the earth's surface of −118 decibel-watts per meter squared per megahertz (dbW/m²/MHz). Thus, using approximately 2 bits per second per hertz (bits/s/Hz), there is approximately 1 Gbps of available bandwidth per spot beam.

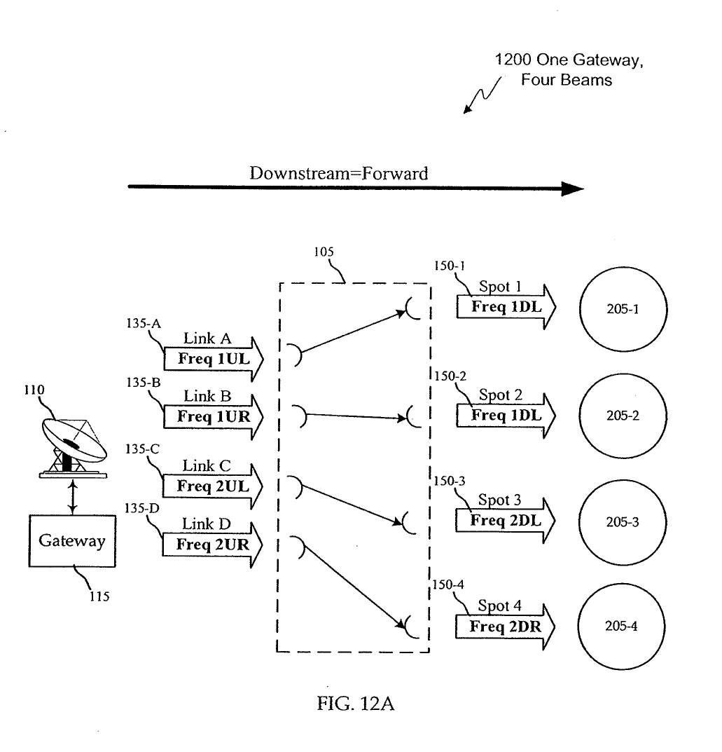

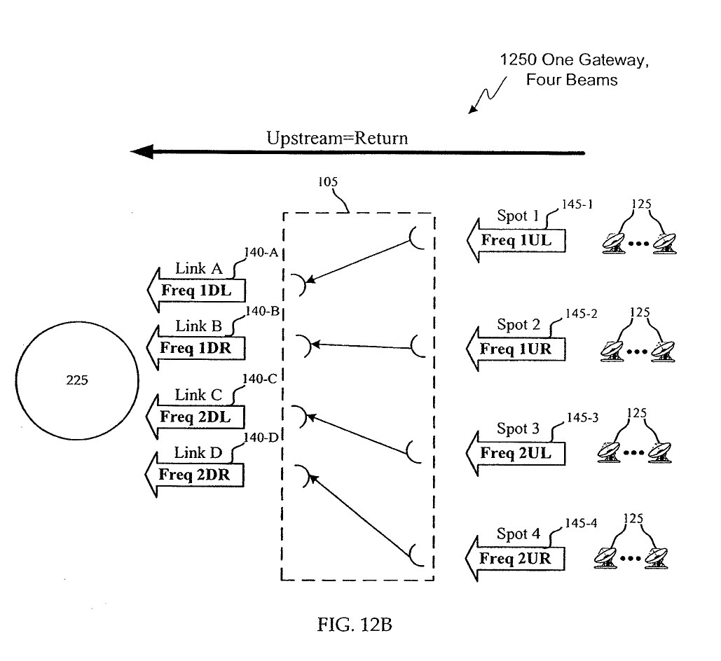

With reference to FIG. 12A, an embodiment of a forward link distribution system 1200 is shown. The gateway 115 is shown coupled to an antenna 110, which generates four downstream signals. A single carrier with 500 MHz of spectrum is used for each of the four downstream uplinks 135. In this embodiment, a total of two-frequencies and two polarizations allow four separate downstream uplinks 135 while using only 1 GHz of the spectrum. For example, link A 135-A could be Freq 1U (27.5-28.0 GHz) with left-hand polarization, link B 135-B could be Freq 1U (27.5-28.0) GHz with right-hand polarization, link C could be Freq 2U (29.5-30 GHz) with left-hand polarization, and link D could be Freq 2U (29.5-30 GHz) with left-hand polarization.

The satellite 105 is functionally depicted as four “bent pipe” connections between a feeder and service link. Carrier signals can be changed through the satellite 105 “bent pipe” connections along with the orientation of polarization. The satellite 105 converts each downstream uplink 135 signal into a downstream downlink signal 150.

In this embodiment, there are four downstream downlinks 150 that each provides a service link for four spot beams 205. The downstream downlink 150 may change frequency in the bent pipe as is the case in this embodiment. For example, downstream uplink A 135-A changes from a first frequency (i.e., Freq 1U) to a second frequency (i.e., Freq 1D) through the satellite 105. Other embodiments may also change polarization between the uplink and downlink for a given downstream channel. Some embodiments may use the same polarization and/or frequency for both the uplink and downlink for a given downstream channel.

Referring next to FIG. 12B, an embodiment of a return link distribution system is shown. This embodiment shows four upstream uplinks 145 from four sets of subscriber terminals 125. A “bent pipe” satellite 105 takes the upstream uplinks 145, optionally changes carrier frequency and/or polarization (not shown), and then redirects them as upstream downlinks 140 to a spot beam for a gateway 115. In this embodiment, the carrier frequency changes between the uplink 145 and the downlink 140, but the polarization remains the same. Because the feeder spot beams to the gateway 115 is not in the coverage area of the service beams, the same frequency pairs may be reused for both service links and feeder links.

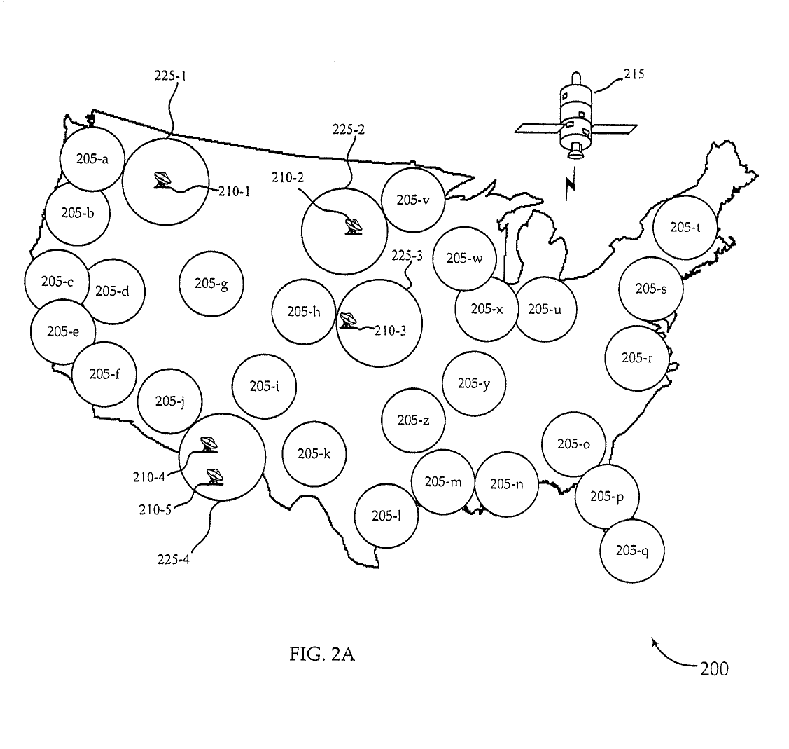

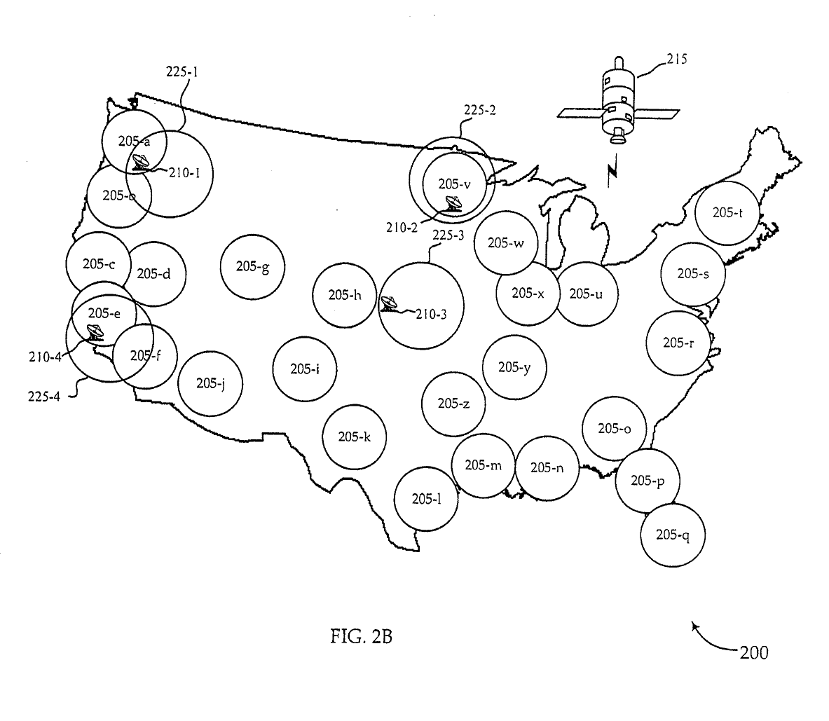

Turning to FIGS. 2A and 2B, examples of a multi-beam system 200 configured according to various embodiments of the invention are shown. The multi-beam system 200 may, for example, be implemented in the network 100 described in FIGS. 1A and 1B. Shown are the coverage of a number of feeder and service spot beam regions 225, 205. In this embodiment, a satellite 215 reuses frequency bands by isolating antenna directivity to certain regions of a country (e.g., United States, Canada or Brazil). As shown in FIG. 2A, there is complete geographic exclusivity between the feeder and service spot beams 205, 225. But that is not the case for FIG. 2B where there may in some instances be service spot beam overlap (e.g., 205-c, 205-d, 205-e), while there is no overlap in other areas. However, with overlap, there are certain interference issues that may inhibit frequency band re-use in the overlapping regions. A four color pattern allows avoiding interference even where there is some overlap between neighboring service beams 205.

In this embodiment, the gateway terminals 210 are also shown along with their feeder beams 225. As shown in FIG. 2B, the gateway terminals 210 may be located in a region covered by a service spotbeam (e.g., the first, second and fourth gateways 210-1, 210-2, 210-4). However, a gateway may also be located outside of a region covered by a service spotbeam (e.g., the third gateway 210-3). By locating gateway terminals 210 outside of the service spotbeam regions (e.g., the third gateway 210-3), geographic separation is achieved to allow for re-use of the allocated frequencies.

There are often spare gateway terminals 210 in a given feeder spot beam 225. The spare gateway terminal 210-5 can substitute for the primary gateway terminal 210-4 should the primary gateway terminal 210-4 fail to function properly. Additionally, the spare can be used when the primary is impaired by weather.

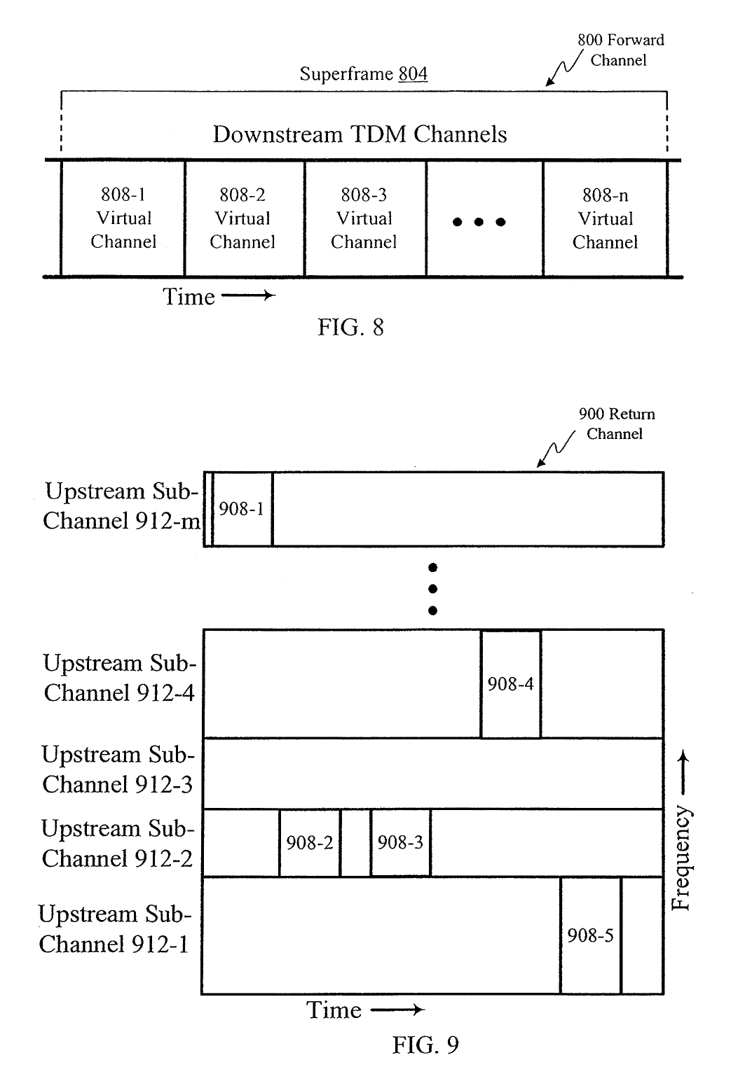

Referring next to FIG. 8, an embodiment of a downstream channel 800 is shown. The downstream channel 800 includes a series of superframes 804 in succession, where each superframe 804 may have the same size or may vary in size. This embodiment divides a superframe 804 into a number of virtual channels 808(1-n). The virtual channels 808(1-n) in each superframe 804 can be the same size or different sizes. The size of the virtual channels 808(1-n) can change between different superframes 804. Different coding can be optionally used for the various virtual channels 808 (1-n). In some embodiments, the virtual channels are as short as one symbol in duration.

With reference to FIG. 9, an embodiment of an upstream channel 900 is shown. This embodiment uses MF-TDMA, but other embodiments can use CDMA, OFDM, or other access schemes. The upstream channel 900 has 500 MHz of total bandwidth in one embodiment. The total bandwidth is divided into m frequency sub-channels, which may differ in bandwidth, modulation, coding, etc. and may also vary in time based on system needs.

In this embodiment, each subscriber terminal 130 is given a two-dimensional (2D) map to use for its upstream traffic. The 2D map has a number of entries where each indicates a frequency sub-channel 912 and time segment 908(1-5). For example, one subscriber terminal 130 is allocated sub-channel m 912-m, time segment one 908-1; sub-channel two 912-2, time segment two 908-2; sub-channel two 912-2, time segment three 908-3; etc. The 2D map is dynamically adjusted for each subscriber terminal 130 according to anticipated need by a scheduler in the SMTS.

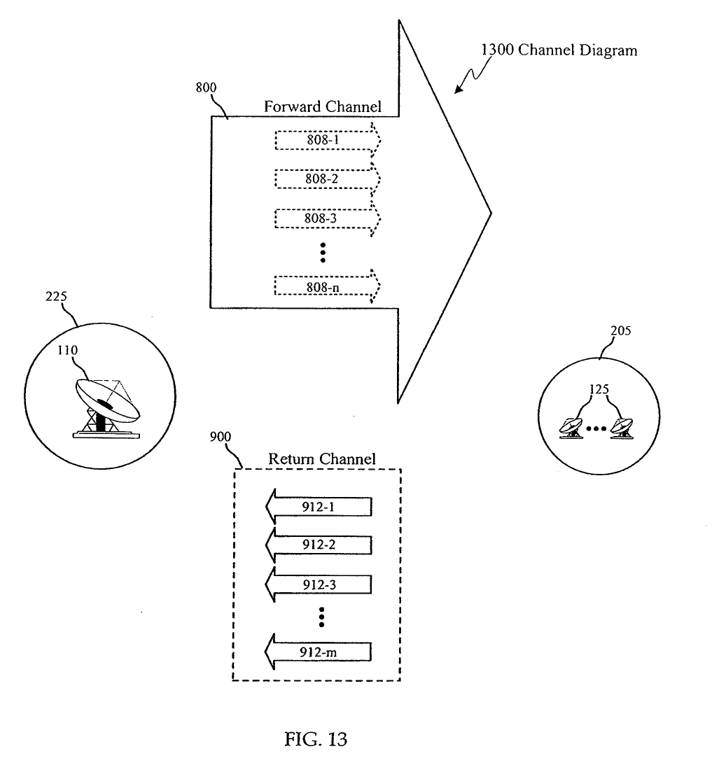

Referring to FIG. 13, an embodiment of a channel diagram is shown. Only the channels for a single feeder spot beam 225 and a single service spot beam 205 are shown, but embodiments include many of each spot beam 225, 205 (e.g., various embodiments could have 60, 80, 100, 120, etc. of each type of spot beam 225, 205). The forward channel 800 includes n virtual channels 808 traveling from the gateway antenna 110 to the service spot beam 205. Each subscriber terminal 130 may be allocated one or more of the virtual channels 808. m MF-TDMA channels 912 make up the return channel 900 between the subscriber terminal (ST) antennas 125 and the feeder spot beam 225.

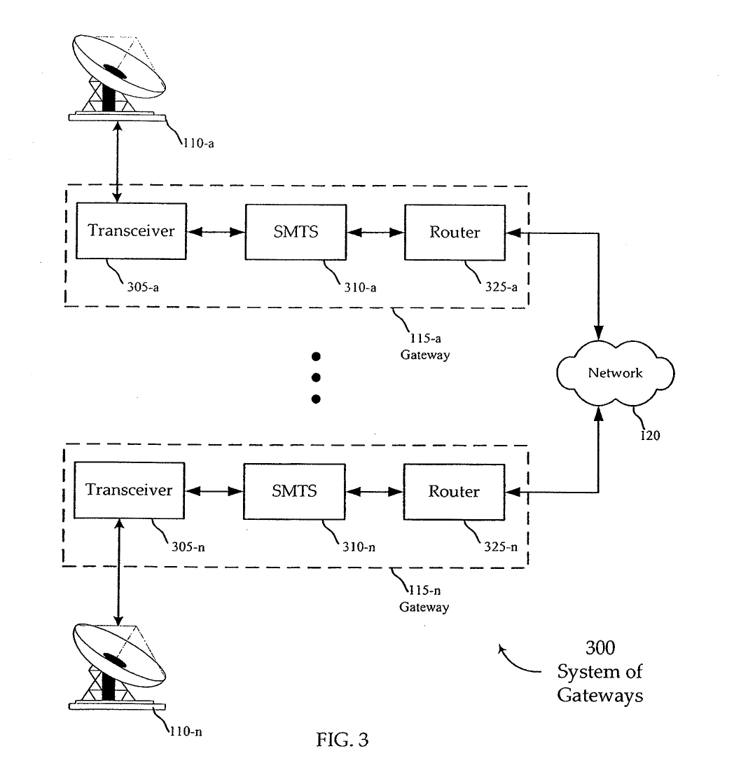

Referring next to FIG. 3, an embodiment of a ground system 300 of gateways 115 is shown in block diagram form. One embodiment could have fifteen active gateways 115 (and possibly spares) to generate sixty service spot beams, for example. The ground system 300 includes a number of gateways 115 respectively coupled to antennas 110. All the gateways 115 are coupled to a network 120 such as the Internet. The network is used to gather information for the subscriber terminals. Additionally, each SMTS communicates with other SMTS and the Internet using the network 120 or other means not shown.

Each gateway 115 includes a transceiver 305, a SMTS 310 and a router 325. The transceiver 305 includes both a transmitter and a receiver. In this embodiment, the transmitter takes a baseband signal and upconverts and amplifies the baseband signal for transmission of the downstream uplinks 135 with the antenna 110. The receiver downconverts and tunes the upstream downlinks 140 along with other processing as explained below. The SMTS 310 processes signals to allow the subscriber terminals to request and receive information and schedules bandwidth for the forward and return channels 800, 900. Additionally, the SMTS 310 provides configuration information and receives status from the subscriber terminals 130. Any requested or returned information is forwarded via the router 325.

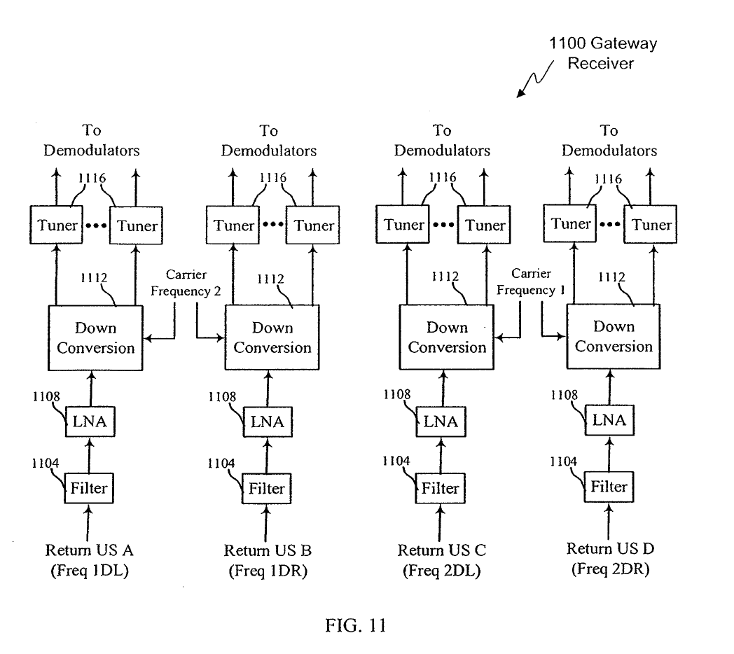

With reference to FIG. 11, an embodiment of gateway receiver 1100 is shown. This embodiment of the receiver 1100 processes four return channels 900 from four different service spot beams 205. The return channels 900 may be divided among four pathways using antenna polarization and/or filtering 1104. Each return channel is coupled to a low-noise amplifier (LNA) 1108. Down conversion 1112 mixes down the signal into its intermediate frequency. Each of the upstream sub-channels 912 is separated from the signal by a number of tuners 1116. Further processing is performed in the SMTS 310.

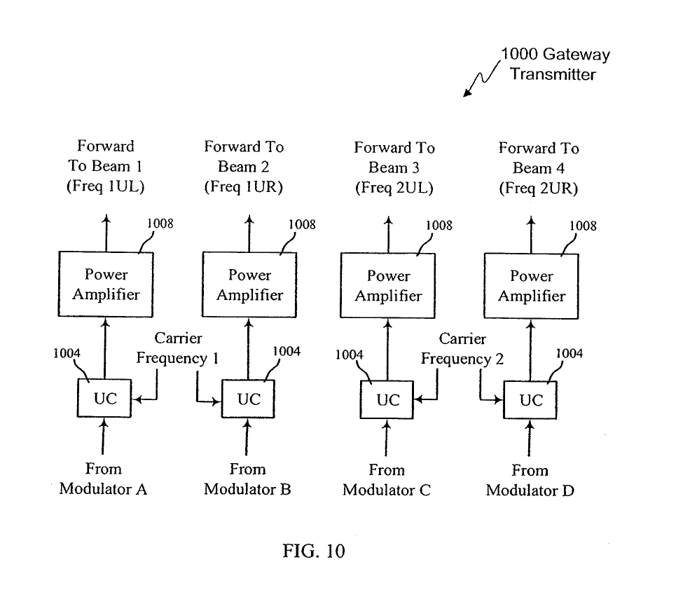

Referring next to FIG. 10, an embodiment of a gateway transmitter 1000 is shown. The downstream channels 800 are received at their intermediate frequencies from the SMTS 310. With separate pathways, each downstream channel 800 is up-converted 1004 using two different carrier frequencies. A power amplifier 1008 increases the amplitude of the forward channel 900 before coupling to the antenna 110. The antenna 110 polarizes the separate signals to keep the four forward channels 800 distinct as they are passed to the satellite 105.

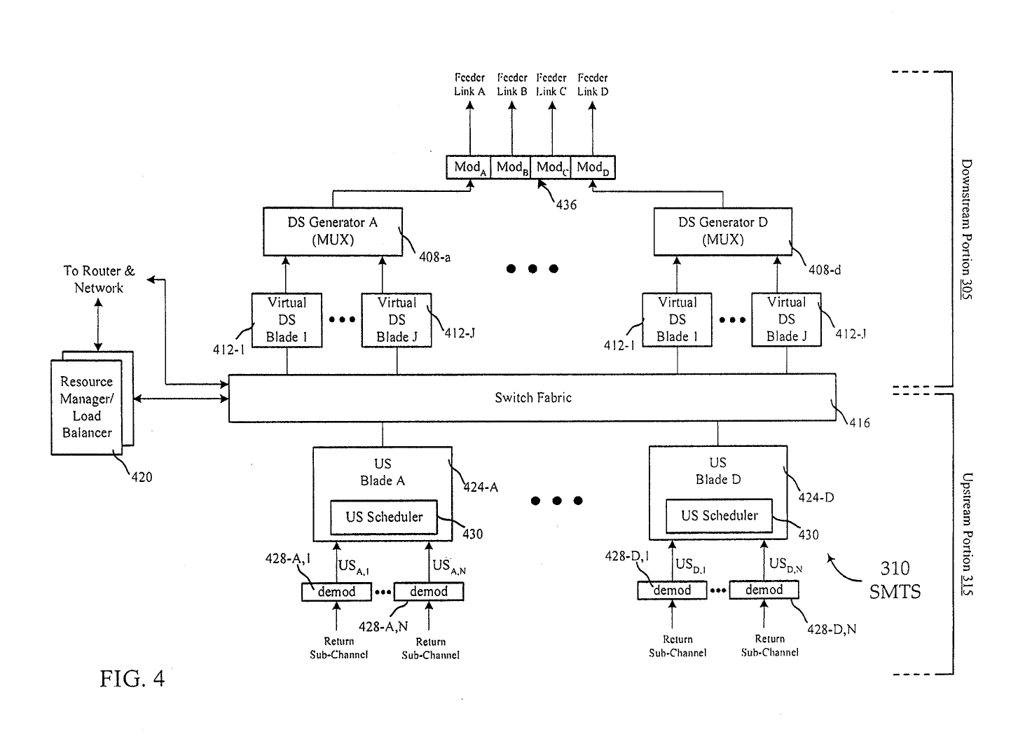

With reference to FIG. 4, an embodiment of a SMTS 310 is shown in block diagram form. Baseband processing is done for the inbound and outbound links 135, 140 by a number of geographically separated gateways 115. Each SMTS 310 is generally divided into two sections, specifically, the downstream portion 305 to send information to the satellite 105 and the upstream portion 315 to receive information from the satellite 105.

The downstream portion 305 takes information from the switching fabric 416 through a number of downstream (DS) blades 412. The DS blades 412 are divided among a number of downstream generators 408. This embodiment includes four downstream generators 408, with one for each of the downstream channels 800. For example, this embodiment uses four separate 500 MHz spectrum ranges having different frequencies and/or polarizations. A four-color modulator 436 has a modulator for each respective DS generator 408. The modulated signals are coupled to the transmitter portion 1000 of the transceiver 305 at an intermediate frequency. Each of the four downstream generators 408 in this embodiment has J virtual DS blades 412.

The upstream portion 315 of the SMTS 310 receives and processes information from the satellite 105 in the baseband intermediate frequency. After the receiver portion 1100 of the transceiver 305 produces all the sub-channels 912 for the four separate baseband upstream signals, each sub-channel 912 is coupled to a different demodulator 428. Some embodiments could include a switch before the demodulators 428 to allow any return link sub-channel 912 to go to any demodulator 428 to allow dynamic reassignment between the four return channels 908. A number of demodulators are dedicated to an upstream (US) blade 424.

The US blades 424 serve to recover the information received from the satellite 105 before providing it to the switching fabric 416. The US scheduler 430 on each US blade 424 serves to schedule use of the return channel 900 for each subscriber terminal 130. Future needs for the subscriber terminals 130 of a particular return channel 900 can be assessed and bandwidth/latency adjusted accordingly in cooperation with the Resource Manager and Load Balancer (RM/LB) block 420.

The RM/LB block 420 assigns traffic among the US and DS blades. By communication with other RM/LB blocks 420 in other SMTSes 310, each RM/LB block 420 can reassign subscriber terminals 130 and channels 800, 900 to other gateways 115. This reassignment can take place for any number of reasons, for example, lack of resources and/or loading concerns. In this embodiment, the decisions are done in a distributed fashion among the RM/LB blocks 420, but other embodiments could have decisions made by one master MR/LB block or at some other central decision-making authority. Reassignment of subscriber terminals 130 could use overlapping service spot beams 205, for example.

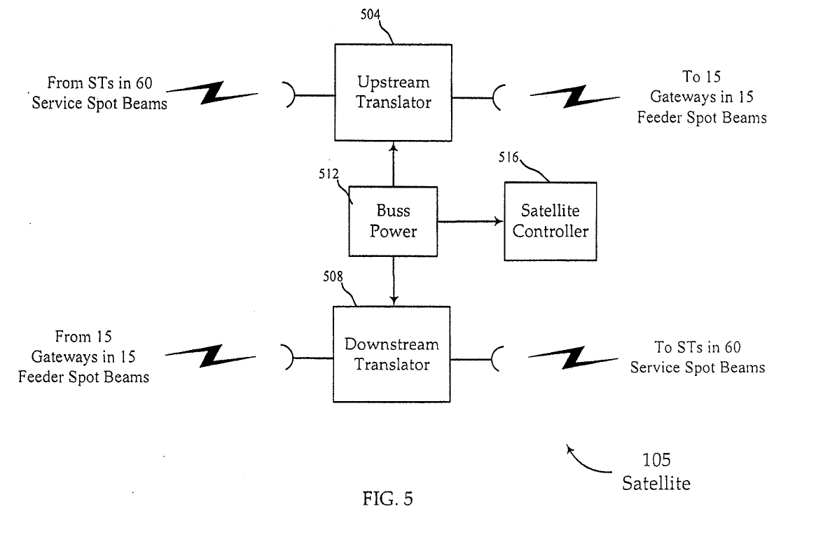

Referring next to FIG. 5, an embodiment of a satellite 105 is shown in block diagram form. The satellite 105 in this embodiment communicates with fifteen gateways 115 and all STs 130 using sixty feeder and service spot beams 225, 205. Other embodiments could use more or less gateways/spot beams. Buss power 512 is supplied using a power source such as chemical fuel, nuclear fuel and/or solar energy. A satellite controller 516 is used to maintain attitude and otherwise control the satellite 105. Software updates to the satellite 105 can be uploaded from the gateway 115 and performed by the satellite controller 516.

Information passes in two directions through the satellite 105. A downstream translator 508 receives information from the fifteen gateways 115 for relay to subscriber terminals 130 using sixty service spot beams 205. An upstream translator 504 receives information from the subscriber terminals 130 occupying the sixty spot beam areas and relays that information to the fifteen gateways 115. This embodiment of the satellite can switch carrier frequencies in the downstream or upstream processors 508, 504 in a “bent-pipe” configuration, but other embodiments could do baseband switching between the various forward and return channels 800, 900. The frequencies and polarization for each spot beam 225, 205 could be programmable or preconfigured.

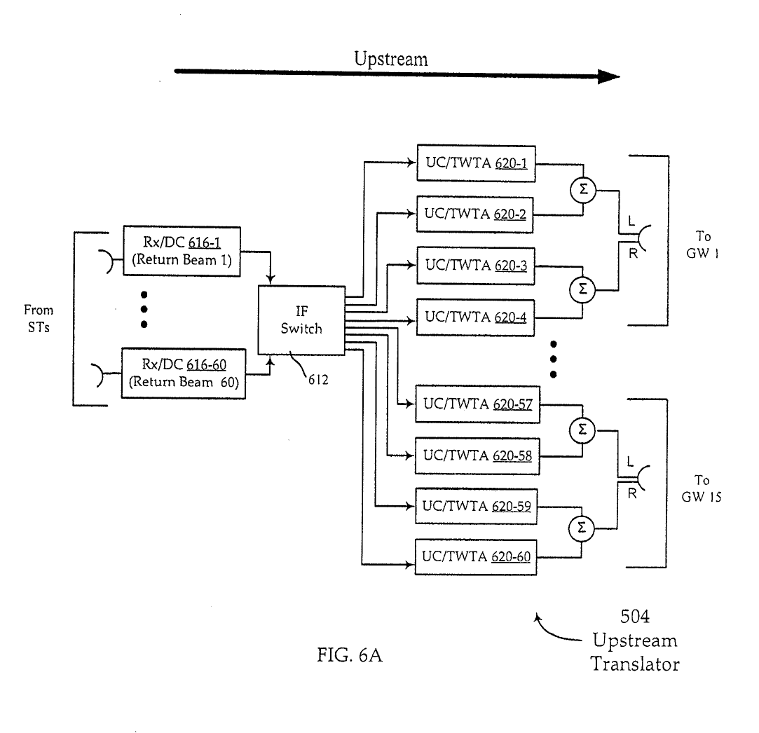

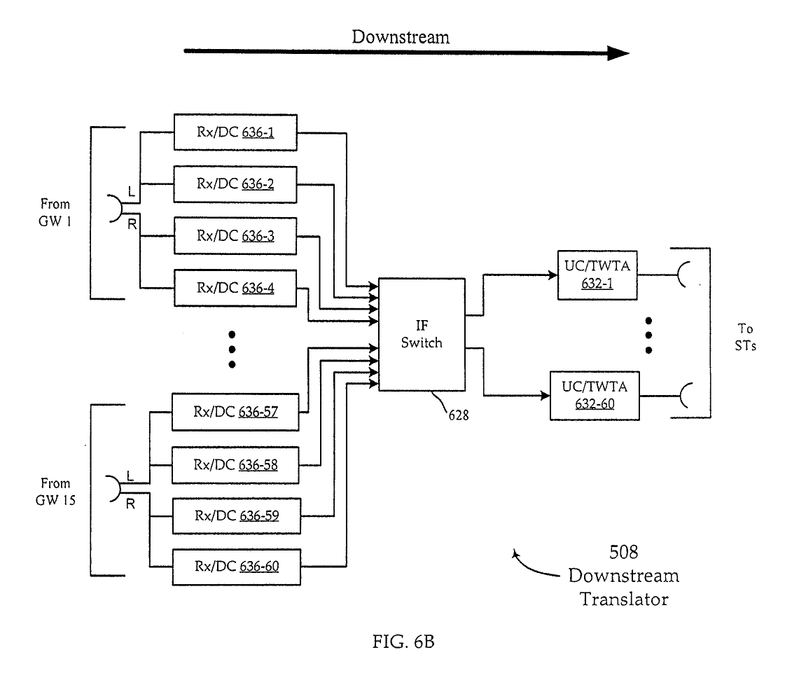

With reference to FIG. 6A, an embodiment of an upstream translator 504 is shown in block diagram form. A Receiver and Downconverter (Rx/DC) block 616 receives all the return link information for the area defined by a spot beam 205 as an analog signal before conversion to an intermediate frequency (IF). There is a Rx/DC block 616 for each service spot beam area 205. An IF switch 612 routes a particular baseband signal from a Rx/DC block 616 to a particular upstream downlink channel. The upstream downlink channel is filled using an Upconverter and Traveling Wave Tube Amplifier (UC/TWTA) block 620. The frequency and/or polarization can be changed through this process such that each upstream channel passes through the satellite 105 in a bent pipe fashion.

Each gateway 115 has four dedicated UC/TWTA blocks 620 in the upstream translator 504. Two of the four dedicated UC/TWTA blocks 620 operate at a first frequency range and two operate at a second frequency range in this embodiment. Additionally, two use right-hand polarization and two use left-hand polarization. Between the two polarizations and two frequencies, the satellite 105 can communicate with each gateway 115 with four separate upstream downlink channels.

Referring next to FIG. 6B, an embodiment of a downstream translator 508 is shown as a block diagram. Each gateway 115 has four downstream uplink channels to the satellite 105 by use of two frequency ranges and two polarizations. A Rx/DC block 636 takes the analog signal and converts the signal to an intermediate frequency. There is a Rx/DC block 636 for all sixty downstream uplink channels from the fifteen gateways 115. The IF switch 612 connects a particular channel 800 from a gateway 115 to a particular service spot beam 205. Each IF signal from the switch 628 is modulated and amplified with a UC/TWTA block 632. An antenna broadcasts the signal using a spot beam to subscriber terminals 130 that occupy the area of the spot beam. Just as with the upstream translator 504, the downstream translator 508 can change carrier frequency and polarization of a particular downstream channel in a bent-pipe fashion.

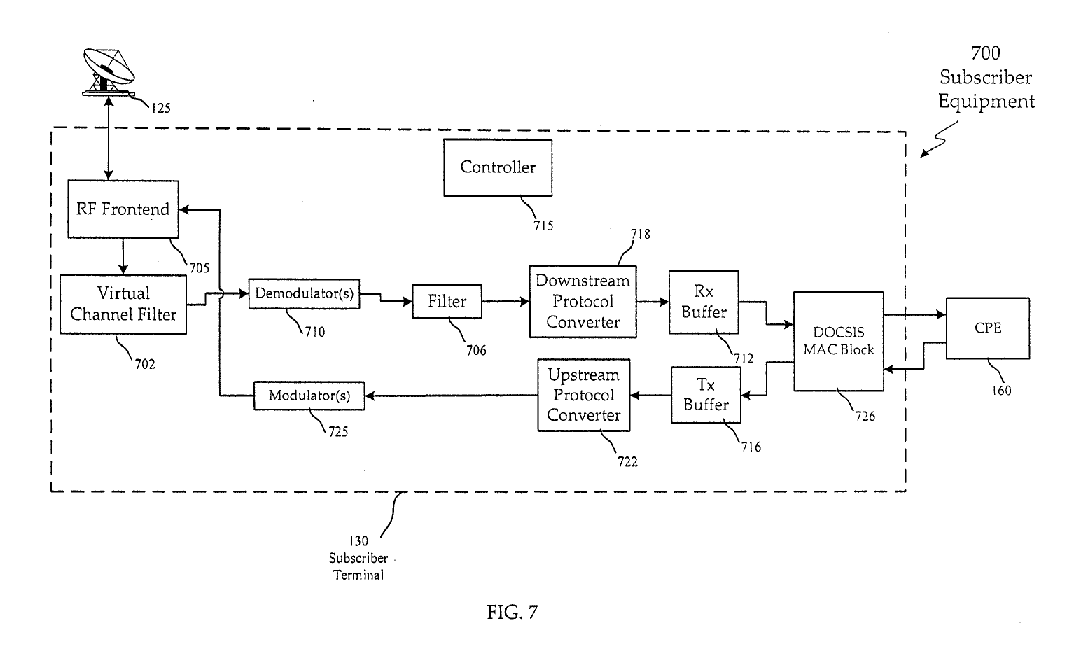

FIG. 7 comprises a block diagram illustrating a set of subscriber equipment 700 which may be located at a subscriber location for the reception and transmission of communication signals. Components of this set of subscriber equipment 700 may, for example, comprise the antenna 125, associated subscriber terminal 130 and any consumer premises equipment (CPE) 160, which may be a computer, a network, etc.

An antenna 125 may receive signals from a satellite 105. The antenna 125 may comprise a VSAT antenna, or any of a variety other antenna types (e.g., other parabolic antennas, microstrip antennas, or helical antennas). In some embodiments, the antenna 125 may be configured to dynamically modify its configuration to better receive signals at certain frequency ranges or from certain locations. From the antenna 125, the signals are forwarded (perhaps after some form of processing) to the subscriber terminal 130. The subscriber terminal 130 may include a radio frequency (RF) frontend 705, a controller 715, a virtual channel filter 702, a modulator 725, a demodulator 710, a filter 706, a downstream protocol converter 718, an upstream protocol converter 722, a receive (Rx) buffer 712, and a transmit (Tx) buffer 716.

In this embodiment, the RF frontend 705 has both transmit and receive functions. The receive function includes amplification of the received signals (e.g., with a low noise amplifier (LNA)). This amplified signal is then downconverted (e.g., using a mixer to combine it with a signal from a local oscillator (LO)). This downconverted signal may be amplified again with the RF frontend 705, before processing of the superframe 804 with the virtual channel filter 702. A subset of each superframe 804 is culled from the downstream channel 800 by the virtual channel filter 702, for example, one or more virtual channels 808 are filtered off for further processing.

A variety of modulation and coding techniques may be used at the subscriber terminal 130 for signals received from and transmitted to a satellite. In this embodiment, modulation techniques include BPSK, QPSK, 8PSK, 16APSK, 32PSK. In other embodiments, additional modulation techniques may include ASK, FSK, MFSK, and QAM, as well as a variety of analog techniques. The demodulator 710 may demodulate the down-converted signals, forwarding the demodulated virtual channel 808 to a filter 706 to strip out the data intended for the particular subscriber terminal 130 from other information in the virtual channel 808.

Once the information destined for the particular subscriber terminal 130 is isolated, a downstream protocol converter 718 translates the protocol used for the satellite link into one that the DOCSIS MAC block 726 uses. Alternative embodiments could use a WiMAX MAC block or a combination DOCSIS/WiMAX block. A Rx buffer 712 is used to convert the high-speed received burst into a lower-speed stream that the DOCSIS MAC block 726 can process. The DOCSIS MAC block 726 is a circuit that receives a DOCSIS stream and manages it for the CPE 160. Tasks such as provisioning, bandwidth management, access control, quality of service, etc. are managed by the DOCSIS MAC block 726. The CPE can often interface with the DOCSIS MAC block 726 using Ethernet, WiFi, USB and/or other standard interfaces. In some embodiments, a WiMax block 726 could be used instead of a DOCSIS MAC block 726 to allow use of the WiMax protocol.

It is also worth noting that while a downstream protocol converter 718 and upstream protocol converter 722 may be used to convert received packets to DOCSIS or WiMax compatible frames for processing by a MAC block 726, these converters will not be necessary in many embodiments. For example, in embodiments where DOCSIS or WiMax based components are not used, the protocol used for the satellite link may also be compatible with the MAC block 726 without such conversions, and the converters 718, 722 may therefore be excluded.

Various functions of the subscriber terminal 130 are managed by the controller 715. The controller 715 may oversee a variety of decoding, interleaving, decryption, and unscrambling techniques, as known in the art. The controller may also manage the functions applicable to the signals and exchange of processed data with one or more CPEs 160. The CPE 160 may comprise one or more user terminals, such as personal computers, laptops, or any other computing devices as known in the art.

The controller 715, along with the other components of the subscriber terminal 130, may be implemented in one or more Application Specific Integrated Circuits (ASICs), or a general purpose processor adapted to perform the applicable functions. Alternatively, the functions of the subscriber terminal 130 may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The controller may be programmed to access memory unit (not shown). It may fetch instructions and other data from the memory unit, or write data to the memory-unit.

As noted above, data may also be transmitted from the CPE 160 through the subscriber terminal 130 and up to a satellite 105 in various communication signals. The CPE 160, therefore, may transmit data to DOCSIS MAC block 726 for conversion to the DOCSIS protocol before that protocol is translated with an upstream protocol converter 722. The slow-rate data waits in the Tx buffer 716 until it is burst over the satellite link.

The processed data is then transmitted from the Tx buffer 716 to the modulator 725, where it is modulated using one of the techniques described above. In some embodiments, adaptive or variable coding and modulation techniques may be used in these transmissions. Specifically, different modulation and coding combinations, or “modcodes,” may be used for different packets, depending on the signal quality metrics from the antenna 125 to the satellite 105. Other factors, such as network and satellite congestion issues, may be factored into the determination, as well. Signal quality information may be received from the satellite or other sources, and various decisions regarding modcode applicability may be made locally at the controller, or remotely. The RF frontend 705 may then amplify and upconvert the modulated signals for transmission through the antenna 125 to the satellite.

Herein follows a description of a specific aspect of the invention

### Multi-Service Provider Subscriber Authentication

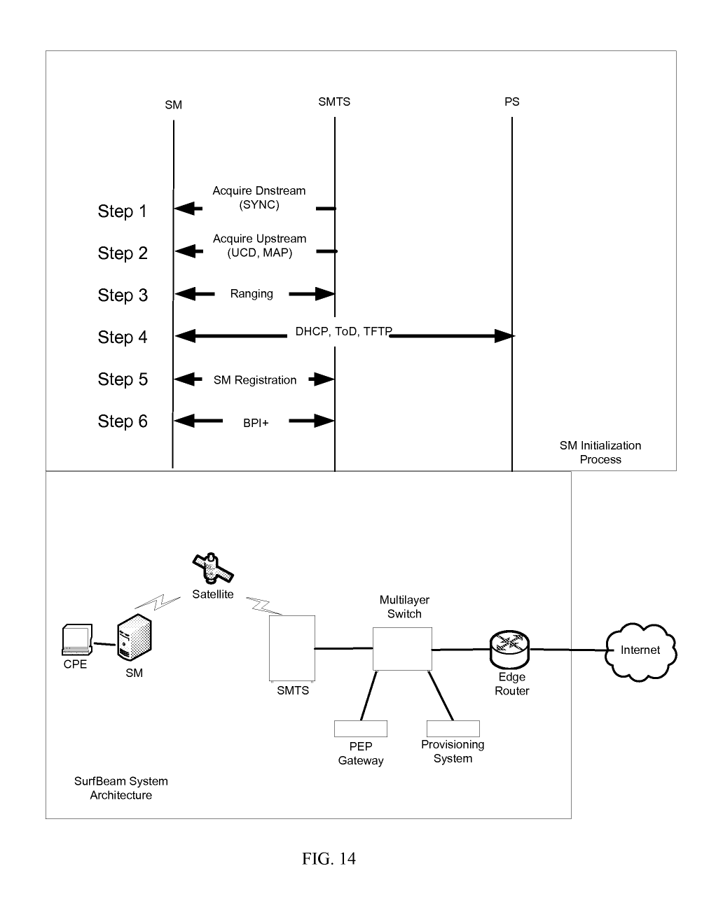

FIG. 14 illustrates the system architecture of the satellite communication system as hereinabove described, further illustrating the user SM initialization process without the use of Network Access Provider Authentication (NAPA) according to the present invention.

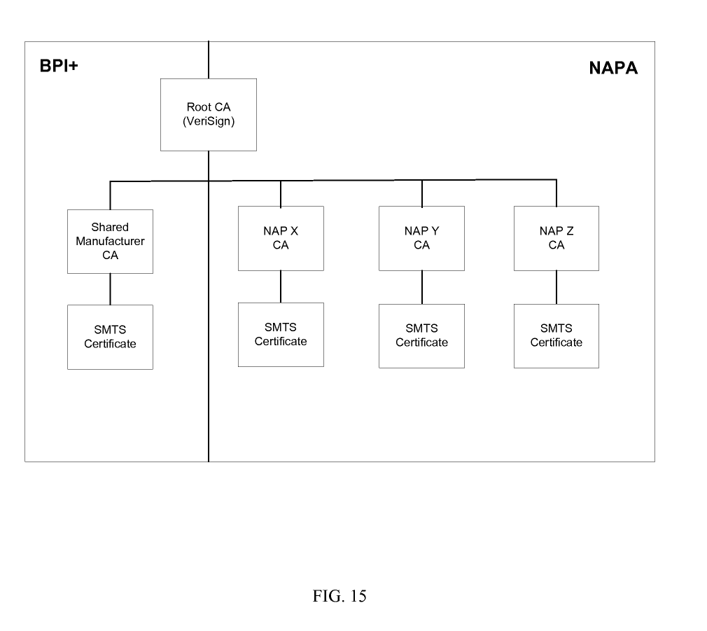

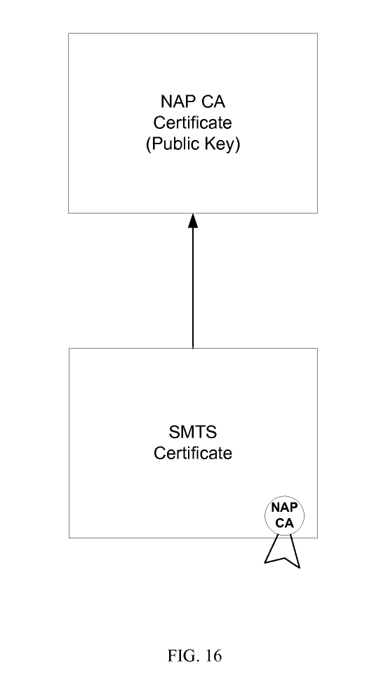

The following assumptions are made:
The following entities are secure and trusted. If any of the entities below is compromised, the Network Access Provider Authentication (NAPA) will likely break down.
   SM codes and configurations
   Authentication algorithm (i.e., the RSA digital signature algorithm)
   Private key (for the RSA digital signature algorithm)
The following entities are not secure or not trusted.
   Satellite communications channel (i.e., eavesdropping)
   SMTS at other Network Access Providers (NAPs)
The certificate management architecture of the present invention has the structure as shown in FIG. 15, where a plurality of NAPs each have associated therewith an SMTS certificate. Note that the certificate management architecture for BPI+ is beyond the scope of this disclosure, and it is shown for reference purpose only.
The SM validates the SMTS Certificate through the validation chain as shown in FIG. 16, namely through a public key NAPA CA certificate, typically by means of public key encryption.
The network access provicer (NAP) undertakes the responsibility for enabling/provisioning the NAPA for the SMTS.
An assumption, though not a specific requirement is that the user terminal satellite modem manufacturer undertakes the responsibility for enabling/provisioning the NAPA for the user SM, and is thus the source of relevant safeguards.

The NAPA procedure is described herein. The NAPA procedure is incorporated into the user SM initialization process. When the NAPA procedure is enabled, the user SM verifies the NAP identify upon entering the network. Thereupon the protocol operation of the NAPA procedure after the NAPA is enabled/provisioned. The enabling/provisioning of the NAPA procedure is explained hereinafter.

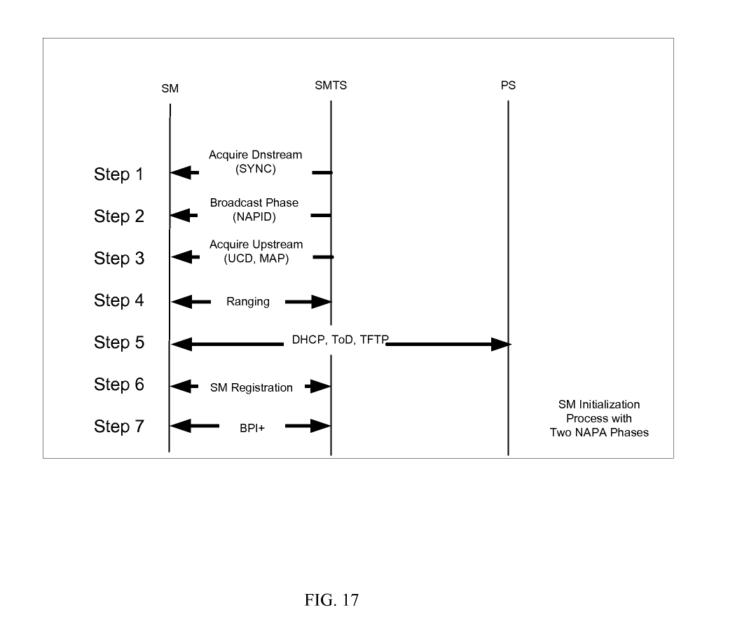

FIG. 17 shows the SM initialization process that adds the NAPA procedure. The NAPA procedure consists of the following two phases. In the first phase (also referred to as the broadcast phase), the SM verifies the NAP identifier that is broadcasted in the downstream. In the second phase (also referred to as the interactive phase), the SM further verifies the NAP identity by using the challenge/response protocol. Both phases are described in details below.

The broadcast phase follows immediately after the downstream acquisition step in the SM initialization process. During the broadcast phase, the SM verifies that it acquires the downstream from the rightful NAP (before advancing to the upstream acquisition step and transmitting on the upstream in the ranging step). The SMTS broadcasts the NAP identifier that is carried in a new MAC Management message, referred to as the NAP Identification (NAPID) message in this paper. The SMTS may broadcast the NAPID message along with every UCD message; alternatively, the SMTS may reduce the frequency of the NAPID message broadcast for reducing the bandwidth overhead. The NAPID message includes the following information:
SMTS identification data (e.g., SMTS serial number, SMTS manufacturer, SMTS manufacturing location, etc),
SMTS Certificate, that contains the SMTS identification data and the SMTS RSA public key (to be used in the NAPA interactive phase, and also referred to as the SMTS public key or NAPA public key), for verifying the SMTS identification data and for verifying the binding between the SMTS identification data and the SMTS public key. (The SMTS Certificate is signed by the NAP Certificate Authority private key. FIG. 15 shows the certificate management architecture).

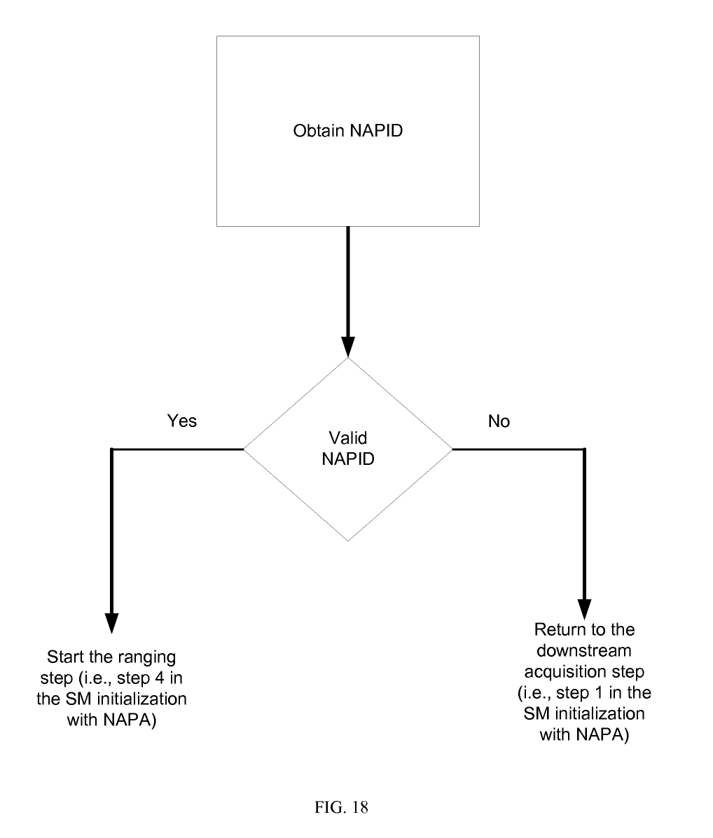

FIG. 18 shows the user SM operational flow chart for the broadcast phase. During the broadcast phase, the user SM validates the SMTS Certificate in the NAPID message and determines whether to continue advancing the initialization process on the current downstream/upstream (in the case of receiving a valid SMTS Certificate) or to scan for another downstream (in the case of receiving an invalid SMTS Certificate). The SM validates the SMTS Certificate using the following criteria. A SMTS Certificate is valid if:
The SMTS Certificate chains to the NAP Certificate in the SM; and
The SMTS Certificate signature can be verified with the public key in the NAP Certificate in the SM; and
The SMTS identification data in the SMTS Certificate matches the SMTS identification data in the NAPID message.

The SMTS Certificate uniquely identifies the NAP of each SMTS chassis. If the SM acquires the downstream from the rightful NAP/SMTS, the SM will receive a valid SMTS Certificate in the NAPA broadcast phase and will continue advancing the initialization process on the current downstream/upstream; otherwise, the SM will receive an invalid SMTS Certificate and will scan for another downstream.

The NAPA broadcast phase is vulnerable to the malicious NAP that launches playback attacks by cloning/broadcasting the SMTS identification data and SMTS Certificate. The NAPA interactive phase repairs the above vulnerability. However, the broadcast phase alone may be sufficient during the early stage of the subject network deployment (because these NAPs do not compete with each other).

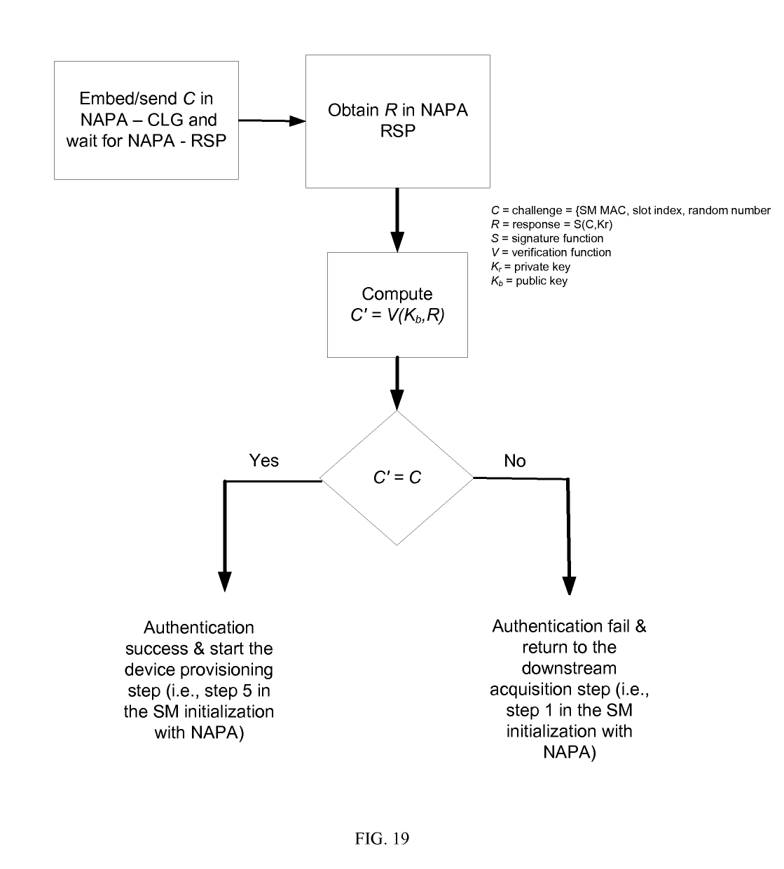

The interactive phase follows immediately after the ranging step in the SM initialization process. The interactive phase employs the signature algorithm described in for example, RSA Laboratories, “PKCS #1 v2.0: RSA Cryptography Standard,” Oct. 1, 1998, and the challenge/response authentication mechanism. FIG. 19 shows the SM operational flow chart for the interactive phase. The SM sends “challenge” values that are embedded in the initial ranging request (RNG-REQ) message. The challenge values include the SM MAC address (as part of the MAC Management message header in the initial RNG-REQ message) and the mini-slot counter index (as derived from the upstream MAP timing reference). Note that the initial RNG-REQ message is not altered for carrying these two challenge values above; thus, the challenge values do not consume additional upstream bandwidth. Upon receiving the SM challenge (i.e., the initial RNG-REQ message), the SMTS generates the digital signature of the challenges values using the SMTS private key (i.e., NAPA private key). Then, the SMTS replies to the SM challenge with the digital signature (i.e., the “response”) that is carried in a new time-length-value tuple (TLV) in the initial ranging response (RNG-RSP) message. Upon receiving the SMTS response (i.e., the initial RNG-RSP message), the SM validates the digital signature by using the SMTS public key (i.e., NAPA public key) that is received from the NAPID message during the broadcast phase. If the SM successfully authenticates the NAP, then the SM advances to the device-provisioning step (i.e., DHCP/ToD/TFTP) in the initialization process; otherwise, the SM returns to the downstream acquisition step.

The details of the interactive phase are subject to changes. There exist two other alternative options for inserting the interactive phase into the SM initialization process:
Where the interactive phase is a stand-alone step that follows immediately after the ranging step, and
Where the interactive phase is embedded in the registration step.

The protocol operation of these two options would work very similarly to the baseline above. The major differences are in implementation-related implications. The details of these two options are omitted for now to simplify the explanation.

It should be noted that the systems, methods, and software discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow chart, a structure diagram, or a block diagram. Although they may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the terms “storage medium” or “storage device” may represent one or more devices for storing data, including read only memory (ROM), random access memory (RAM), magnetic RAM, core memory, magnetic disk storage mediums, optical storage mediums, flash memory devices or other computer readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A method for subscriber service authentication in a satellite communication system, the method comprising:
sending a request from a user terminal via a satellite modem to a gateway in a satellite system with access to a plurality of virtual channels that are not secure and trusted;
invoking at a satellite modem termination system at the gateway, in response to the request, a user authentication scheme that allows the satellite modem termination system to determine whether the user terminal is an subscriber to a subscribed service that can have access to the subscribed service;
authorizing the user terminal to have access to the subscribed service if the user authentication scheme in the satellite modem termination system at the gateway determines that the user terminal is a legitimate subscriber to the subscribed service; and
blocking the user terminal to prevent user terminal access to the subscribed service if the user authentication scheme determines the user terminal is not an authorized subscriber that can have to access the subscribed service.

2. The method according to claim 1, wherein said authentication scheme includes:
initializing the user terminal when it is without network access provider authentication, with satellite modem codes, satellite modem configurations and corresponding authentication procedures that are secure and trusted.

3. The method according to claim 1, wherein said authentication scheme includes initialization, said initialization comprising:
in a first phase, verifying a user terminal's network access provider identity through a network access provider identifier that is broadcast in a downstream channel; and
in a second phase, further verifying, at the user terminal said network access provider identity by means of a challenge/response protocol.

4. The method according to claim 3 further including the step of:
performing a downstream acquisition step in the user terminal initialization process.

5. The method according to claim 3 including, during the first phase and after an upstream acquisition step, causing the user terminal to verify that it has acquired the downstream channel from its rightful network access provider; thereafter
as part of a ranging step, transmitting on an upstream channel; thereupon
broadcasting the network access provider identifier that is carried in a fresh MAC Management message along with a UCD message.

6. The method according to claim 3, wherein in said second phase, causing the user terminal to send a challenge with challenge values embedded in an initial ranging request message such that no additional upstream bandwidth is consumed.

7. The method according to claim 6 wherein, upon receiving the user terminal challenge,
generating at the satellite modem terminal system a digital signature according to the challenges values using a private key of the satellite modem terminal system corresponding to a network access provider authentication private key; thereafter,
causing the satellite modem terminal system to reply to a challenge of the user terminal with a response based on a digital signature that is carried in a new time-length-value tuple in the initial ranging response message; then
upon receiving the satellite modem terminal system response, causing the user terminal to validate the digital signature by using the satellite modem terminal system public key that was received during the first phase as a network access provider identification message; and
upon successful authentication by the user terminal of the NAP, advancing the user terminal to a device-provisioning step in the initialization process; otherwise,
returning the user terminal to the downstream acquisition step.

8. An apparatus for subscriber service authentication in a satellite communication system, comprising:
means for sending a request from a user terminal via a satellite to a gateway;
invoking means, at the gateway, responsive response to the request, for invoking a user authentication scheme to determine whether the user terminal can have access to a subscribed service;
authorizing means, communicatively coupled to the invoking means, for authorizing the user terminal to have access to the subscribed service if the user authentication scheme determines that the user terminal is a legitimate subscriber to the subscribed service; and
preventing means, communicatively coupled to the invoking means, for preventing the user terminal from having access to the subscribed service if the user authentication scheme determines the user terminal is not authorized to access the subscribed service.

9. A method for authenticating service providers in a satellite communications network, the method comprising:
receiving at a user terminal a network access provider identifier via a satellite from a gateway;
determining at the user terminal whether a certificate included in the network access provider identifier is valid;
if the certificate is not valid, waiting to receive at the user terminal another network access provider identifier to determine validity of another certificate included in the another network access provider identifier;
if the certificate is valid, sending a challenge value from the user terminal via the satellite to the gateway;
generating a digital signature of the challenge value by the gateway;
sending the digital signature from the gateway via the satellite to the user terminal; and
validating the digital signature by the user terminal using a public key.

10. The method according to claim 9 wherein the determining whether the certificate is valid depends at least in part on at least one of a certificate chain to the certificate, a verification of a certificate signature with the public key, or information contained in the certificate matching information data from the network access provider.

11. The method according to claim 9 further comprising advancing the user terminal to a device-provisioning process if the user terminal successfully authenticates the network access provider.

12. An apparatus for authenticating service providers in a satellite communications network, comprising:
means for receiving at a user terminal a network access provider identifier via a satellite from a gateway;
means for determining at the user terminal whether a certificate included in the network access provider identifier is valid;
means, responsive to whether the certificate is valid, for sending a challenge value from the user terminal via the satellite to the gateway;
means for generating a digital signature of the challenge value by the gateway;
means for sending the digital signature from the gateway via the satellite to the user terminal; and
means for validating the digital signature by the user terminal using a public key.
